(19) United States
(12) Patent Application Publication
(10) Pub. No.: US 2025/0121600 A1
(43) Pub. Date: Apr. 17, 2025

(54) LIQUID EJECTION DEVICE

(71) Applicant: SEIKO EPSON CORPORATION, Tokyo (JP)

(72) Inventors: Shinji KANEMARU, MATSUMOTO-SHI (JP); Masaki ICHIKAWA, MATSUMOTO-SHI (JP); Ryohei KINOSHITA, MATSUMOTO-SHI (JP); Keita FUJI, MATSUMOTO-SHI (JP); Shintaro MIYAMOTO, SHIOJIRI-SHI (JP); Keiichiro FUKUMASU, KITAKYUSHU-SHI (JP)

(21) Appl. No.: 18/917,371

(22) Filed: Oct. 16, 2024

(30) Foreign Application Priority Data
Oct. 17, 2023 (JP) 2023-178704

(51) Int. Cl. B41J 2/17; B41J 2/175; B41J 29/377

(52) U.S. Cl. CPC B41J 2/1714; B41J 2/175; B41J 29/377

(57) ABSTRACT

A liquid ejection device includes a device main body including a liquid ejection head configured to eject a liquid onto a medium, a reading unit configured to read an image on a document, and an operation unit on which a user performs an operation, wherein a flow path of a gaseous body is formed between the device main body and the reading unit, the gaseous body flowing in a direction from the liquid ejection head to the operation unit, and a meandering formation portion is provided to a part of the flow path, the meandering formation portion narrowing the flow path and causing the flow path to meander.

The present application is based on, and claims priority from JP Application Serial Number 2023-178704, filed Oct. 17, 2023, the disclosure of which is hereby incorporated by reference herein in its entirety.

### BACKGROUND

### 1. Technical Field

The present disclosure relates to a liquid ejection device that performs recording by ejecting a liquid onto a medium.

### 2. Related Art

Examples of a liquid ejection device that performing recording by ejecting a liquid onto a medium include an inkjet printer. As indicated in JP-A-2007-160689, it has been known that, in an inkjet printer, an ejected ink is not ejected onto a medium, but floats as mist and adheres to a constituent element of the device, which causes an adverse effect.

The inkjet printer described in JP-A-2007-160689 is a multifunction peripheral in which a scanner unit, which is one example of an image reading device, is provided to an upper part of a printer main body. The inkjet printer includes a recess portion, which extends along a movement region of a carriage, at the bottom portion of the scanner unit. With this, a rapid flow of the air inside the printer main body is suppressed, and dispersion of ink mist inside the printer main body is suppressed.

In the multifunction peripheral, a gaseous body containing ink mist rides an updraft inside the printer main body, and moves to the outside of the device through the gap between the printer main body and the scanner unit. As a result, there may be a risk that the ink mist adheres to the constituent element on the outer side of the device and a risk that the ink mist leaks to the outer side of the device and the ink adheres to other parts in the periphery of the printer.

### SUMMARY

In order to solve the above-mentioned problem a liquid ejection device according to the present disclosure includes a device main body including a liquid ejection head configured to eject a liquid onto a medium, a reading unit configured to open and close at an upper part of the device main body and read an image on a document, and an operation unit on which a user performs an operation, wherein a flow path of a gaseous body is formed between the device main body and the reading unit, the gaseous body flowing in a direction from the liquid ejection head to the operation unit, and a meandering formation portion is provided to a part of the flow path, the meandering formation portion narrowing the flow path and causing the flow path to meander.

Further, a liquid ejection device according to the present disclosure includes a device main body including a liquid ejection head configured to eject a liquid onto a medium, and a reading unit configured to open and close at an upper part of the device main body and read an image on a document, wherein a flow path of a gaseous body is formed between the device main body and the reading unit, the gaseous body flowing in a direction from the liquid ejection head to an outside of the device, and a meandering formation portion is provided to a part of the flow path, the meandering formation portion narrowing the flow path and causing the flow path to meander.

### BRIEF DESCRIPTION OF THE DRAWINGS

FIG. 1 is a perspective view of a printer.

FIG. 2 is a perspective view of a scanner unit.

FIG. 3 is a perspective view of a motor that drives a carriage of the scanner unit.

FIG. 4 is a cross-sectional view of a heat radiation member.

FIG. 5 is a perspective view of an earth line that grounds an operation panel.

FIG. 6 is a perspective view of a coupling portion of the earth line that grounds the operation panel.

FIG. 7 is a perspective view of the scanner unit and the printer when a cover is removed.

FIG. 8 is a perspective view of a front frame.

FIG. 9 is a perspective view of the front frame and an ink accommodation unit when a cover is removed.

FIG. 10 is a perspective view of the bottom surface of the scanner unit.

FIG. 11 is a perspective view of the bottom surface of the scanner unit.

FIG. 12 is a cross-sectional view of the scanner unit, a device main body, and the ink accommodation unit.

FIG. 13 is a cross-sectional view of the ink accommodation unit.

FIG. 14 is a cross-sectional view of the scanner unit, the device main body, and the operation panel.

FIG. 15 is an enlarged view of the part A in FIG. 12.

FIG. 16 is an enlarged view of the part B in FIG. 14.

FIG. 17 is a view illustrating a modification of FIG. 15.

### DESCRIPTION OF EMBODIMENTS

Hereinafter, the present disclosure is schematically described.

A liquid ejection device according to a first aspect includes a device main body including a liquid ejection head configured to eject a liquid onto a medium, a reading unit configured to open and close at an upper part of the device main body and read an image on a document, and an operation unit on which a user performs an operation, wherein a flow path of a gaseous body is formed between the device main body and the reading unit, the gaseous body flowing in a direction from the liquid ejection head to the operation unit, and a meandering formation portion is provided to a part of the flow path, the meandering formation portion narrowing the flow path and causing the flow path to meander.

According to the present aspect, at the part of the flow path for the gaseous body flowing from the liquid ejection head to the operation unit, the meandering formation portion that narrows the flow path and causes the flow path to meander is provided. Thus, the flow of the gaseous body flowing in the direction from the liquid ejection head to the operation unit is inhibited by the meandering formation portion, and the liquid mist is easily captured by the meandering formation portion. As a result, adhesion of the liquid mist to the operation unit can be suppressed, and a hand and a finger of a user can be prevented from getting dirty.

In a second aspect, which is dependent on the first aspect, the liquid ejection device includes a liquid accommodation unit configured to accommodates a liquid ejected from the liquid ejection head, wherein the liquid accommodation unit is arranged at a device front surface being a side surface facing a user among side surfaces of the device main body, the liquid accommodation unit includes an injection port for a liquid and an opening/closing lever configured to open and close the injection port, and the operation unit is the opening/closing lever.

According to the present aspect, in a configuration in which the operation unit is the opening/closing lever, the actions and effects of the first aspect described above are acquired.

In a third aspect, which is dependent on the first aspect, the liquid ejection device includes an operation panel configured to receive various operations, wherein the operation panel is arranged on a device front surface being a side surface facing a user among side surfaces of the device main body, and the operation unit is the operation panel.

According to the present aspect, in a configuration in which the operation unit is the operation panel, the actions and effects of the first aspect described above are acquired.

In a fourth aspect, which is dependent on the first aspect, the liquid ejection device includes a liquid accommodation unit configured to accommodate a liquid ejected from the liquid ejection head, the liquid accommodation unit being arranged on a device front surface being a side surface facing a user among side surfaces of the device main body, an operation panel configured to receive various operations, the operation panel being arranged on the device front surface, and a plurality of the operations units, wherein the liquid accommodation unit includes an injection port for a liquid and an opening/closing lever configured to open and close the injection port, and the plurality of operation units include the opening/closing lever and the operation panel.

According to the present aspect, in a configuration in which the plurality of operation units are provided and the plurality of operation units include the operation panel and the opening/closing lever, the actions and effects of the first aspect described above are acquired.

A liquid ejection device according to a fifth aspect includes a device main body including a liquid ejection head configured to eject a liquid onto a medium, and a reading unit configured to open and close at an upper part of the device main body and read an image on a document, wherein a flow path of a gaseous body is formed between the device main body and the reading unit, the gaseous body flowing in a direction from the liquid ejection head to an outside of the device, and a meandering formation portion is provided to a part of the flow path, the meandering formation portion narrowing the flow path and causing the flow path to meander.

According to the present aspect, at the part of the flow path for the gaseous body flowing from the liquid ejection head to the outside of the device, the meandering formation portion that narrows the flow path and causes the flow path to meander is provided. Thus, the flow of the gaseous body from the liquid ejection head to the outside of the device is inhibited, and the liquid mist is easily captured by the meandering formation portion. As a result, leakage of the liquid mist to the outside of the device can be suppressed.

In a sixth aspect, which is dependent on any one of the first to fifth aspects, the meandering formation portion includes a first projection portion that projects from the device main body toward the reading unit and a second projection portion that projects from the reading unit toward the device main body, and the first projection portion and the second projection portion overlap with each other in a vertical direction.

According to the present aspect, the meandering formation portion is configured to include the first projection portion that projects from the device main body to the reading unit and the second projection portion that projects from the reading unit to the device main body. Thus, the meandering formation portion can be configured with a simple configuration at a low cost. Further, the first projection portion and the second projection portion overlap with each other in the vertical direction. Thus, the flow path can securely be caused to meander.

In a seventh aspect, which is dependent on the sixth aspect, the first projection portion is arranged at a position closer to the liquid ejection head than the second projection portion.

The gaseous body containing the liquid mist rides an updraft, and then the liquid mist moves to the outside of the device through the gap between the reading unit and the device main body. Therefore, the liquid mist is easily captured by the second projection portion that projects from the reading unit to the device main body, in other words, downward.

According to the present aspect, the first projection portion is arranged at a position closer to the liquid ejection head than the second projection portion. Thus, the gaseous body containing the liquid mist is guided to the second projection portion by the first projection portion. With this, the liquid mist can easily be captured by the second projection portion, and the liquid mist flowing to the outside of the device can be reduced more securely.

In an eighth aspect, which is dependent on the seventh aspect, the second projection portion projects obliquely toward the liquid ejection head.

According to the present aspect, the second projection portion projects obliquely toward the liquid ejection head. Thus, the liquid mist can be captured more easily by the second projection portion, and the liquid mist flowing to the outside of the device can be reduced more securely.

Hereinafter, the present disclosure is specifically described.

Note that, in each diagram, an X-axis direction is a device width direction, a −X direction is a right direction as viewed from a user when a device front surface faces a user, and a +X direction is a left direction as viewed from a user.

A Y-axis direction is a device depth direction, a +Y direction is a direction from a device rear surface to the device front surface, and a −Y direction is a direction from the device front surface to the device rear surface. Note that, in the present embodiment, a surface at which an operation panel 15 is provided among device side surfaces, that is, a side surface in the +Y direction is the device front surface.

Further, a Z-axis direction is a vertical direction, a +Z direction is a vertically upward direction, and a −Z direction is a vertically downward direction.

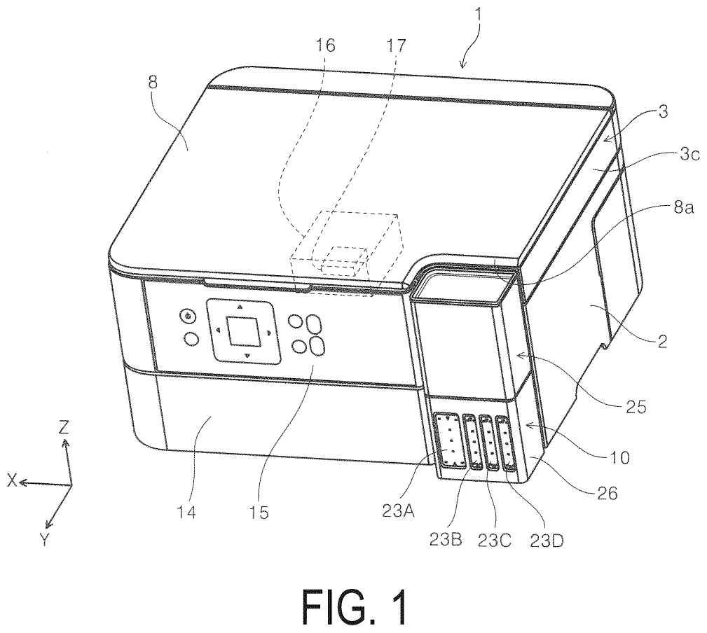

In FIG. 1, an inkjet printer 1, which is one example of a liquid ejection device, is a multifunction peripheral in which a scanner unit 3 is provided at an upper part of a device main body 2, the scanner unit 3, which is one example of a reading unit that reads an image on a document. Hereinafter, the inkjet printer is abbreviated as a “printer”.

The device main body 2 is a main body of the printer 1, and an outer shape thereof is a box-like shape as a whole. The device main body 2 and the scanner unit 3 are configured to be substantially flush with each other at a side surface in the −X direction, that is, a right side surface, and a side surface in the +X direction, that is, a left side surface. Note that the right side surfaces and the left side surfaces of the device main body 2 and the scanner unit 3 are surfaces parallel to a Y-Z plane.

The device main body 2 has a function of performing recording on a medium represented by recording paper, and the scanner unit 3 has a function of reading a document. The device main body 2 includes an ink ejection head 17 that ejects ink, which is one example of a liquid, onto the medium. The ink ejection head 17 is provided to a carriage 16 that moves in the X-axis direction, that is, the medium width direction. The ink is supplied to the ink ejection head 17 from an ink accommodation unit 10, which is one example of a liquid accommodation unit, through an ink tube (not illustrated).

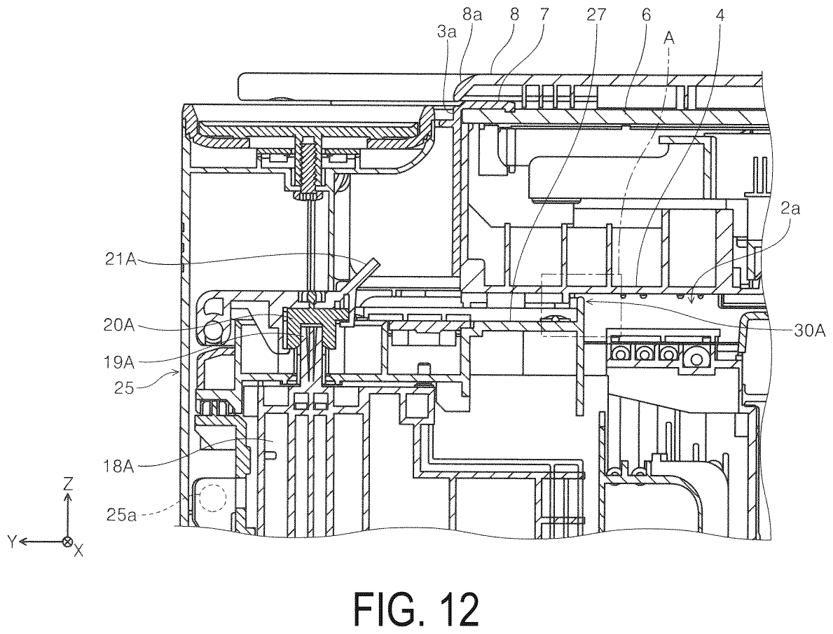

The scanner unit 3 includes a document table 6 (see FIG. 12) and a document cover 8 that can open and close the document table 6, both of which are provided to a unit main body 3c. The document cover 8 is coupled to the unit main body 3c of the scanner unit 3 via a hinge (not illustrated) provided at the rear of the device. The rotation axis of the document cover 8 is parallel to the X-axis direction, and the document cover 8 rotates with the +Y direction, that is, the front of the device as a free end, thereby opening and closing the document table 6. Note that, instead of the document cover 8, a document feeding device for automatically feeding a set document may be provided.

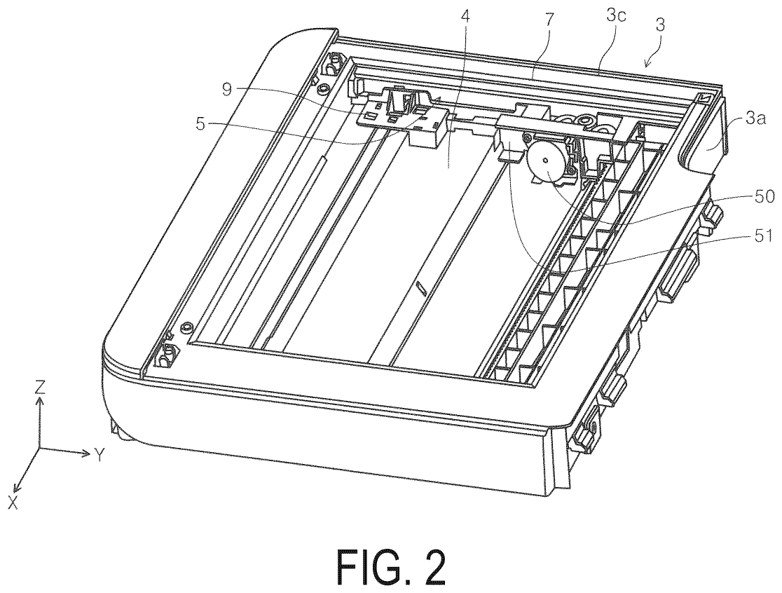

Further, as illustrated in FIG. 2, the scanner unit 3 includes a reading sensor 5 provided to the unit main body 3c. The reading sensor 5 extends in the Y-axis direction. In the present embodiment, the reading sensor 5, which is one example of a reading unit that reads a document, is configured by a contact image sensor (CIS). The reading sensor 5 reads a document placed on the document table 6 (see FIG. 12) while moving in the X-axis direction. For example, the document table 6 is formed of glass. Note that, in FIG. 2, the document table 6 is omitted in illustration.

The reading sensor 5 is provided to a carriage 9 movable in the X-axis direction. The carriage 9 is provided to a lower frame 4 forming the lower part of the scanner unit 3 so as to move in the X-axis direction. Note that, an upper frame 7 forms the upper part of the scanner unit 3. In other words, in the unit main body 3c, the lower part is configured by the lower frame 4, and the upper part is configured by the upper frame 7.

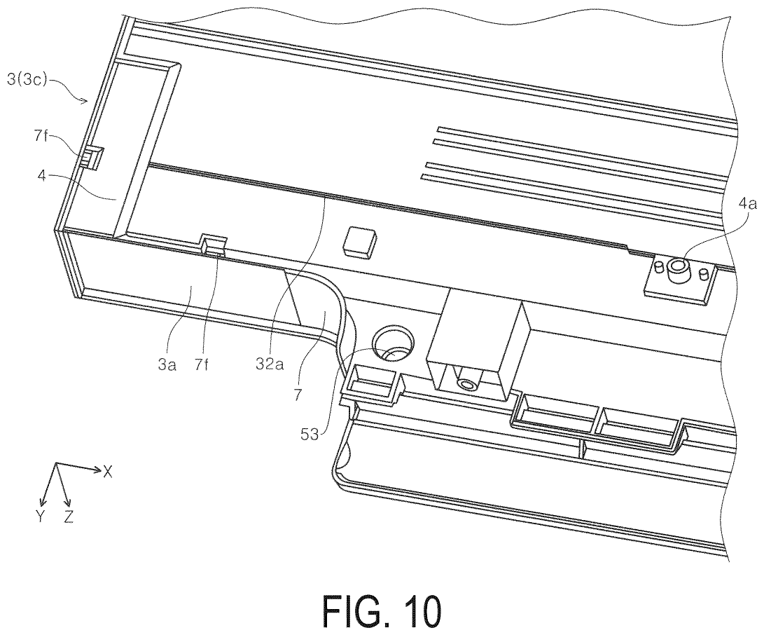

Basically, the lower frame 4 and the upper frame 7 are coupled by a screw. However, as illustrated in FIG. 10, on a side in which a cutout portion 3a, which is described later, is formed (see FIG. 10), the lower frame 4 and the upper frame 7 are coupled by a screw 53, and are further coupled by hooks 7f at two positions. In other words, the two hooks 7f formed at the upper frame 7 catch onto the lower frame 4, thereby coupling the lower frame 4 and the upper frame 7.

Referring back to FIG. 2, a motor 50 is mounted to the carriage 9, and the carriage 9 moves in the X-axis direction by a driving force of the motor 50.

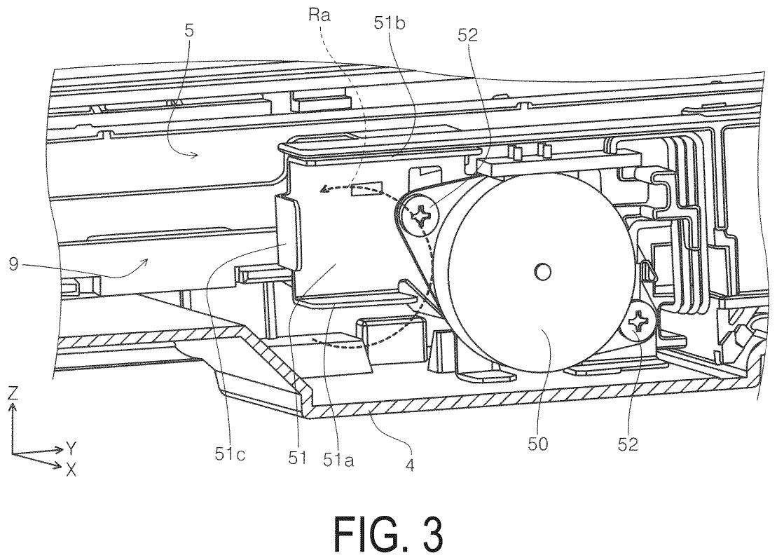

As illustrated in FIG. 3, the motor 50 is fixed to the carriage 9 via a heat radiation member 51. The heat radiation member 51 is formed of a metal plate material, and contacts with the motor 50. The motor 50 and the heat radiation member 51 are fixed to the carriage 9 by two screws 52.

The heat radiation member 51 is formed so that bent upright portions 51a, 51b, and 51c project in the +X direction.

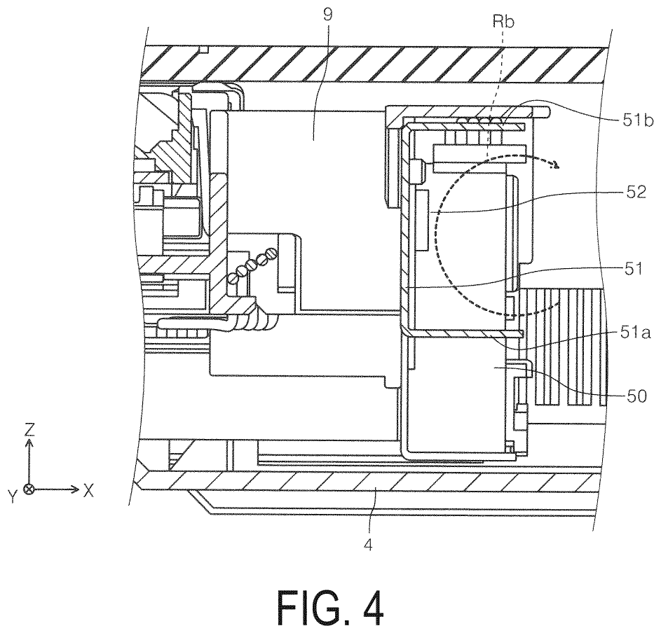

The motor 50 contacts with the heat radiation member 51, and thus heat generated by the motor 50 propagates to the heat radiation member 51. Further, the bent upright portions 51a, 51b, and 51c are formed, and thus natural convection indicated by an arrow Ra in FIG. 3 is generated as viewed in the +X direction. Further, as viewed in the −Y direction, natural convection indicated by an arrow Rb in FIG. 4 is generated. With this, heat is effectively radiated from the motor 50, and a failure due to heat generation at the motor 50 can be suppressed.

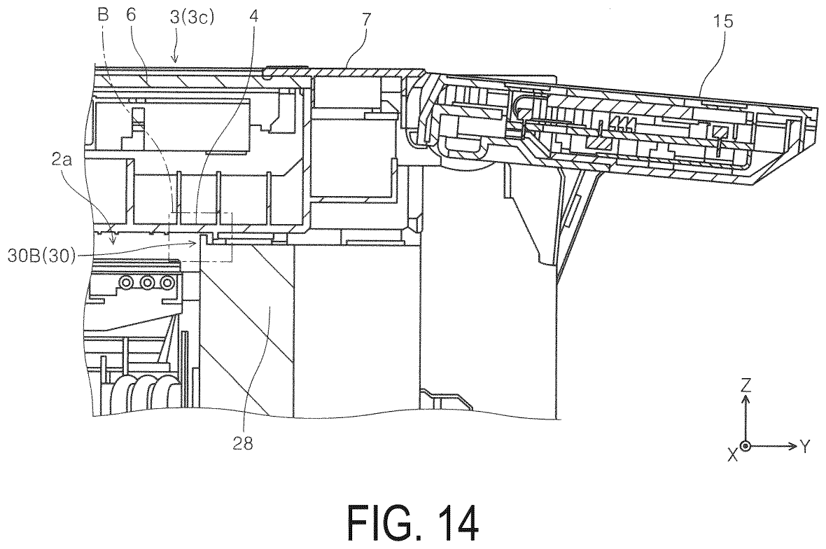

Referring back to FIG. 1, the operation panel 15 for performing various operation settings is provided at the device front surface. The operation panel 15 is tiltable and rotatable between a first state illustrated in FIG. 1 and a second state (see FIG. 14) in which a panel surface 15a being a front surface is oriented in a more vertically upward direction than in the first state. Note that, in the present embodiment, the panel surface 15a in the second state is tilted slightly downward and forms a predetermined angle with respect to a horizontal plane. However, the panel surface 15a in the second state may be parallel to the horizontal plane.

The operation panel 15 is provided to the scanner unit 3. Thus, the operation panel 15 is integrated with the scanner unit 3 in the assembly step.

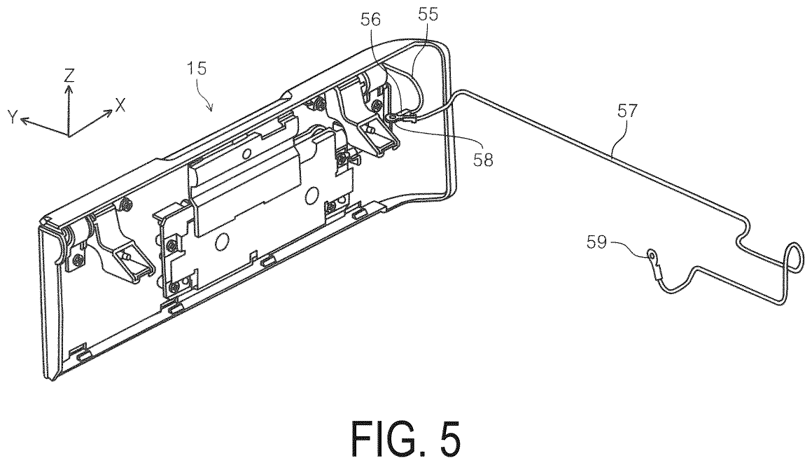

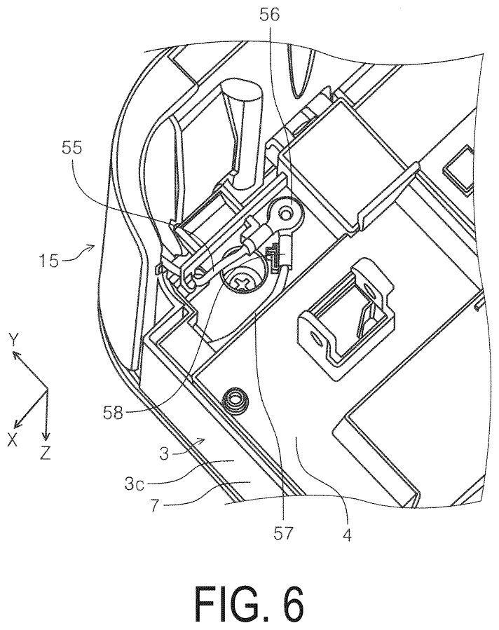

In FIG. 5, the reference symbol 55 indicates a first earth line, and the reference symbol 57 indicates a second earth line. The first earth line 55 extends from the operation panel 15, and the second earth line 57 is routed in the scanner unit 3. A third terminal 59 is attached to one end of the second earth line 57, and the third terminal 59 is electrically coupled to a connection portion (not illustrated) of the device main body 2. When the operation panel 15 is assembled to the scanner unit 3, a first terminal 56 provided at an end of the first earth line 55 and a second terminal 58 provided at the other end of the second earth line 57 contact with each other as illustrated in FIG. 6. Then, in this state, the first terminal 56 and the second terminal 58 can be fixed to the scanner unit 3 by a screw (not illustrated).

With the configuration described above, the operation panel 15 and the scanner unit 3 can be assembled separately, and the operation panel 15 can be grounded with improved workability.

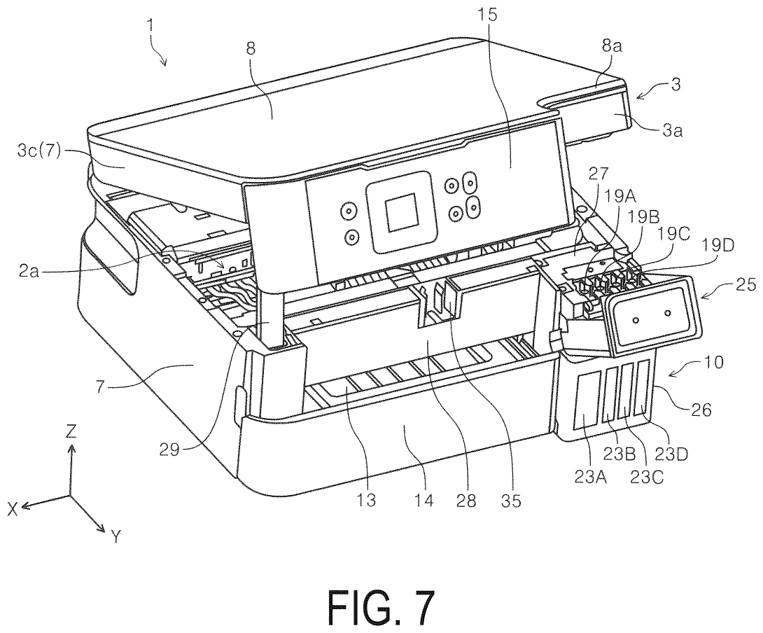

Referring back to FIG. 1, a front surface cover 14 is provided below the operation panel 15. The front surface cover 14 is provided in an openable and closable manner and can have a closed state (FIG. 1) and an open state (not illustrated). When the front surface cover 14 is opened, a discharge tray 13 (see FIG. 7) for receiving a medium that has been subjected to recording and discharged is exposed.

Note that the front surface cover 14 is provided rotatably with respect to a medium accommodation cassette (not illustrated). A medium accommodated in the medium accommodation cassette is sent in the −Y direction by a feeding roller (not illustrated), inverted, subjected to recording while being conveyed in the +Y direction, and discharged in the +Y direction.

The front surface cover 14 in the closed state and the operation panel 15 in the first state are flush with each other as illustrated in FIG. 1.

The scanner unit 3 is coupled to the device main body 2 via the hinge (not illustrated) provided at the rear of the device. The rotation axis of the scanner unit 3 is parallel to the X-axis direction, and the scanner unit 3 rotates with the +Y direction, that is, the front of the device as a free end, thereby opening and closing the upper part of the device main body 2.

FIG. 1 illustrates a state in which the scanner unit 3 is closed, and FIG. 7 illustrates a state in which the scanner unit 3 is opened. When the scanner unit 3 is opened, an inner space 2a of the device main body 2 can be exposed, and processing for removing a jammed medium or other maintenance work can be performed. Note that a state in which the scanner unit 3 is opened can be maintained by an arm 29.

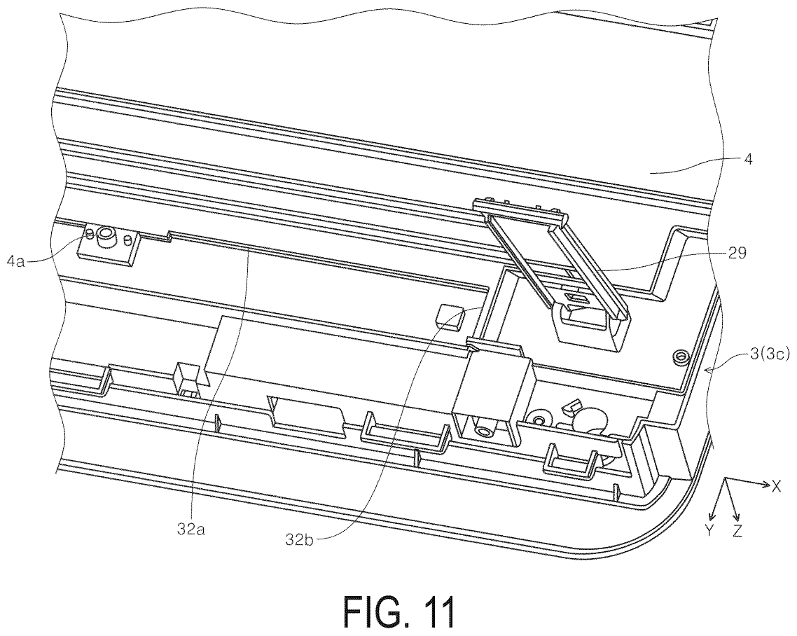

Note that, the reference symbol 28 in FIG. 7 indicates a front frame that forms the front part of the device main body 2. At the center part of the front frame 28, a locking member 35 is provided. An elastic holding portion 35a is formed at the locking member 35. A protrusion 4a (see FIG. 10 and FIG. 11) is formed on the lower side of the scanner unit 3. When the protrusion 4a is inserted into the elastic holding portion 35a, a state in which the scanner unit 3 is closed is maintained.

Next, the ink accommodation unit 10, which is one example of a liquid accommodation unit, is provided in the −X direction, that is, on the right side, at the front surface of the device main body 2.

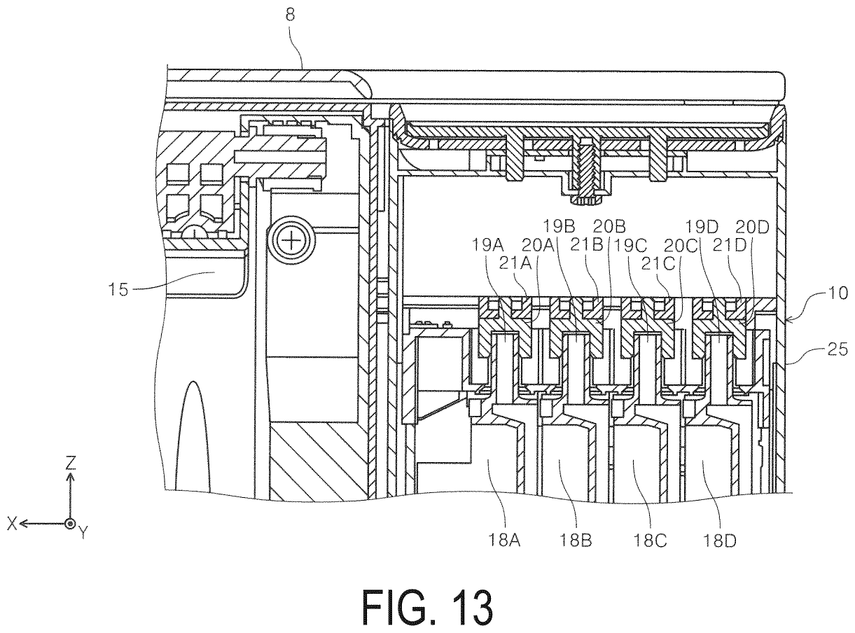

As illustrated in FIG. 13, ink tanks 18A, 18B, 18C, and 18D as liquid accommodation containers are provided inside the ink accommodation unit 10. Note that, when the ink tanks 18A, 18B, 18C, and 18D are not distinguished, they are hereinafter collectively referred to as ink tanks 18. The ink tanks 18 constitute the ink accommodation unit 10.

For example, the ink tank 18A accommodates black ink, and the ink tanks 18B, 18C, and 18D accommodate color inks, for example, yellow, magenta, and cyan inks, respectively.

The ink tanks 18 are provided inside an exterior member 26 illustrated in FIG. 1 and FIG. 7. Opening portions are provided in the front surface of the exterior member 26, and thus remaining amount visual recognition portions 23A, 23B, 23C, and 23D for visual recognition of the remaining ink amounts are exposed at the device front surface.

The remaining amount visual recognition portions 23A, 23B, 23C, and 23D are parts of the ink tanks 18A, 18B, 18C, and 18D, respectively. In other words, the ink tanks 18A, 18B, 18C, and 18D are partially formed to be transparent or semitransparent so that the insides thereof can be visually recognized, and these parts serve as the remaining amount visual recognition portions 23A, 23B, 23C, and 23D. Note that, when it is not necessary to distinguish the remaining amount visual recognition portions 23A, 23B, 23C, and 23D, they are collectively referred to as remaining amount visual recognition portions 23.

Note that the side surface of the exterior member 26 in the −X direction is flush with the side surfaces of the device main body 2 and the scanner unit 3 in the −X direction.

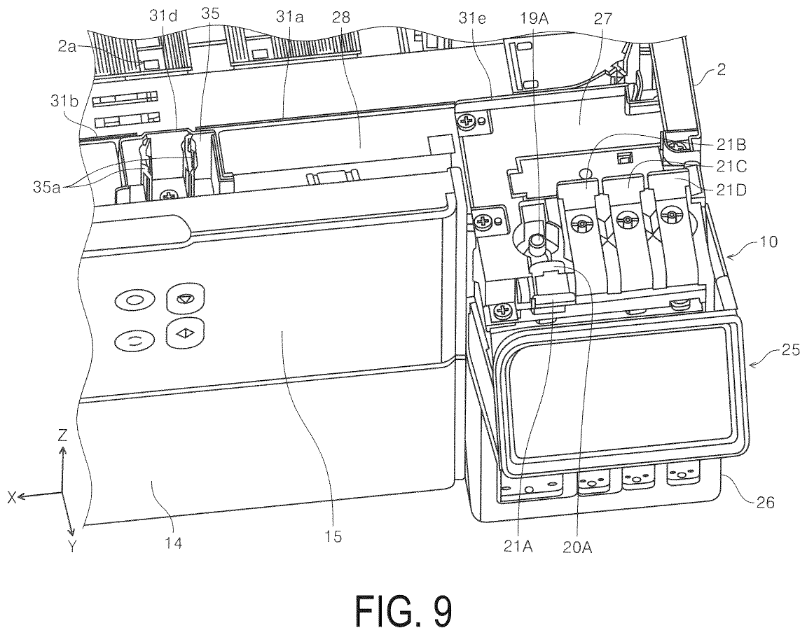

A cover 25 is provided the exterior member 26. The cover 25 is provided rotatably around a rotary shaft 25a (see FIG. 12) provided at the lower part, and rotates to be in a closed state (FIG. 1 and FIG. 12) and a fully opened state (FIG. 7 and FIG. 9). In the present embodiment, an axial center line of the rotary shaft 25a is parallel to the X-axis.

Note that a side surface of the cover 25 in the −X direction is flush with the side surfaces of the device main body 2 and the scanner unit 3 in the −X direction.

Further, a side surface of the cover 25 in the +Y direction, that is, a front surface thereof is flush with the side surface of the exterior member 26 in the +Y direction, that is, the front surface thereof.

As indicated by a change between FIG. 1 and FIG. 7, the cover 25 includes an upper end portion as a free end, and is opened by rotating toward the front of the device from the closed state. Note that the maximum opening angle of the cover 25 is smaller than 90 degrees. The cover 25 is configured so as not to hinder the remaining amount visual recognition portions 23 from being visually recognized even when the cover 25 is fully opened.

When the cover 25 is opened, opening/closing levers 21A, 21B, 21C, and 21D are exposed as illustrated in FIG. 9. FIG. 9 illustrates a state in which the opening/closing levers 21B, 21C, 21D are closed and the opening/closing lever 21A is opened. Note that, when it is not necessary to distinguish the opening/closing levers 21A, 21B, 21C, and 21D, they are hereinafter collectively referred to as opening/closing levers 21.

For example, the opening/closing lever 21A is provided with a sealing cap 20A. The ink tank 18A is provided with an ink supply port 19A, and the ink supply port 19A is exposed by opening the opening/closing lever 21A. The sealing cap 20A is made of an elastic material, and closes the ink supply port 19A when the opening/closing lever 21A is closed.

A user can refill the ink tank 18A with ink through the ink supply port 19A by operating and opening the opening/closing lever 21A and setting an ink refilling bottle (not illustrated) at the ink supply port 19A.

Note that the other ink tanks 18B, 18C and 18D are similarly provided with ink supply ports 19B, 19C and 19D, respectively, as illustrated in FIG. 13. The opening/closing levers 21B, 21C, and 21D are similarly provided with sealing caps 20B, 20C, and 20D, respectively.

When the ink accommodation unit 10 is refilled with ink, a space above the ink accommodation unit 10 may be largely open from the viewpoint of workability. When the scanner unit 3 covers the space above the ink accommodation unit 10, it is necessary to open the scanner unit 3. In order to open the scanner unit 3, a large space above the device is required.

In order to solve such a problem, it is conceivable to provide the ink accommodation unit 10 so as to largely project forward or sidewards of the device, but, in this case, the size of the device increases as a whole.

Thus, in the printer 1 according to the present embodiment, the scanner unit 3 includes a cutout portion 3a at a corner portion on the device front side as illustrated in FIG. 7. Then, the cover 25, which is a part of the ink accommodation unit 10, is inserted into the cutout portion 3a, and also a space above the ink accommodation unit 10 is open.

With such a configuration, it is possible to access the ink accommodation unit 10 from above without opening the scanner unit 3, and to easily perform an operation of refilling the ink accommodation unit 10 with ink. In addition, since a part of the ink accommodation unit 10 is provided in a state of being inserted into the cutout portion 3a, the ink accommodation unit 10 does not largely project forward from the device front surface, and it is possible to suppress an increase in the size of the device.

Note that, in the present embodiment, the printer 1 includes the cutout portion 3a and the ink accommodation unit 10 at the corner portion in the −X direction on the device front side, but may include the cutout portion 3a and the ink accommodation unit 10 at a corner portion in the +X direction on the device front side.

In plan view of the device, the shape of the cutout portion 3a is along the outer shape of the cover 25. Accordingly, a wasteful space is not formed between the cover 25 and the scanner unit 3, which can suppress an increase in the size of the device.

Note that the cutout portion along the outer shape of the cover 25 is formed not only in the unit main body 3c but also in the document cover 8 as indicated by the reference symbol 8a. Accordingly, it is possible to access the ink accommodation unit 10 from above without opening the document cover 8, and to easily perform an operation of refilling the ink accommodation unit 10 with ink. Note that the cutout portion 3a formed in the unit main body 3c and the cutout portion 8a formed in the document cover 8 have substantially the same contour in plan view of the device, that is, as viewed from the +Z direction.

Then, there is a risk that, in the inner space 2a of the device main body 2, the gaseous body containing ink mist rides an updraft and moves to the outside of the device through the gap between the device main body 2 and the scanner unit 3. With this, there may be a risk that the ink mist adheres to the constituent element on the outer side of the device and a risk that the ink mist leaks to the outer side of the device and the ink adheres to other parts in the periphery of the printer. Examples of the constituent element to which the ink mist may adhere include the opening/closing levers 21 constituting the ink accommodation unit 10 and the operation panel 15. The opening/closing lever 21 and the operation panel 15 are examples of an operation unit on which a user performs an operation.

Description is made below on a means for suppressing adhesion of the ink mist to the opening/closing lever 21 and the operation panel 15.

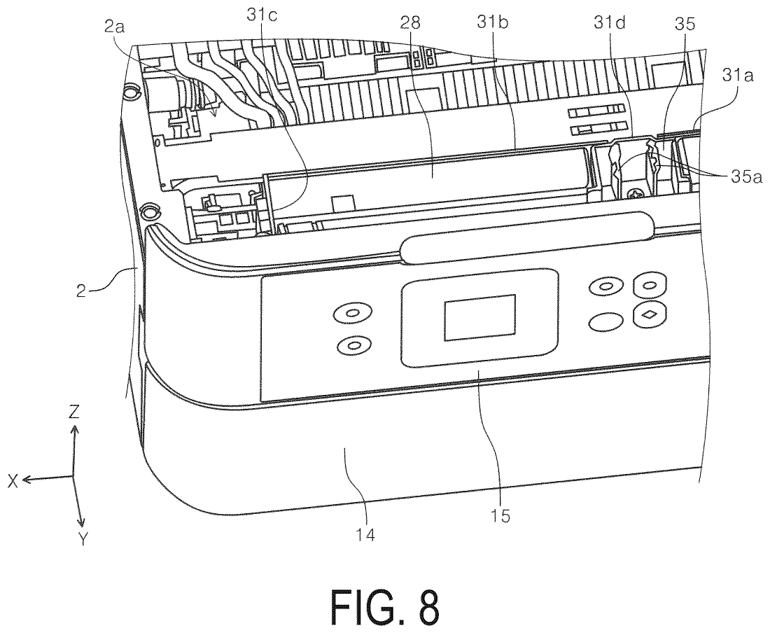

As illustrated in FIG. 8 and FIG. 9, lower ribs 31a, 31b, and 31c that project from the device main body 2 toward the scanner unit 3 are formed at the upper part of the front frame 28. The lower ribs 31a and 31b are formed along the X-axis direction, that is, the device width direction. The lower rib 31c is formed along the Y-axis direction, that is, the device depth direction.

Further, at the locking member 35, a lower rib 31d that projects from the device main body 2 toward the scanner unit 3 is formed. The lower rib 31d is formed along the X-axis direction, that is, the device width direction. The lower rib 31d is positioned between the lower rib 31a and the lower rib 31b.

Further, at an upper frame 27 constituting the ink accommodation unit 10, a lower rib 31e that projects from the device main body 2 toward the scanner unit 3 is formed. The lower rib 31e is formed along the X-axis direction, that is, the device width direction.

The lower ribs 31a, 31b, 31c, 31d, and 31e described above are continuous, and are arranged as a whole so as to extend along the device width direction at the front of the device main body 2.

The lower ribs 31a, 31b, 31c, 31d, and 31e are examples of a first projection portion that projects from the device main body 2 toward the scanner unit 3.

Note that, when it is not necessary to distinguish the lower ribs 31a, 31b, 31c, 31d, and 31e, they are hereinafter collectively referred to as lower ribs 31.

Further, as illustrated in FIG. 10 and FIG. 11, at the lower part of the lower frame 4 constituting the scanner unit 3, upper ribs 32a and 32b that project from the scanner unit 3 toward the device main body 2 are formed. The upper rib 32a is formed along the X-axis direction, that is, the device width direction. Further, the upper rib 32b is formed along the Y-axis direction, that is, the device depth direction.

The upper ribs 32a and 32b described above are continuous, and are arranged as a whole so as to extend along the device width direction at the front of the scanner unit 3.

The upper ribs 32a and 32b are examples of a second projection portion that projects from the scanner unit 3 toward the device main body 2.

Note that, when it is not necessary to distinguish the upper ribs 32a and 32b, they are hereinafter collectively referred to as upper ribs 32.

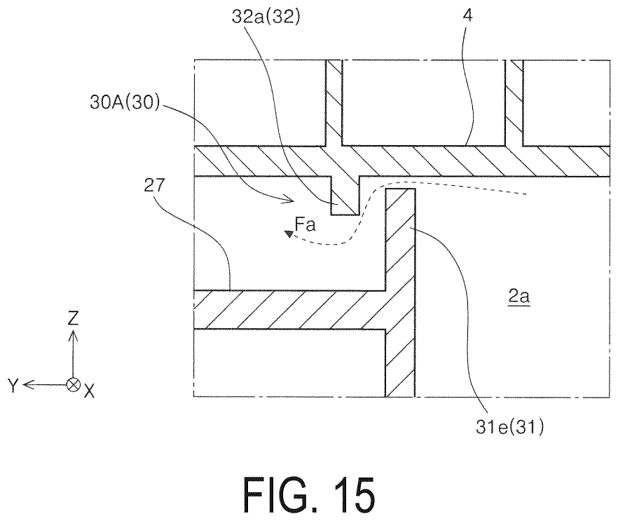

FIG. 12 is a cross-sectional view of the printer 1, which is taken along the Y-Z plane at the position corresponding to the ink supply port 19A, and FIG. 15 is an enlarged view of the part A in FIG. 12.

As illustrated in FIG. 12 and FIG. 15, when the scanner unit 3 is closed with respect to the device main body 2, the lower rib 31e and the upper rib 32a are arranged alternatingly along the Y-axis direction. Note that, in the present embodiment, the lower rib 31e is arranged in the −Y direction with respect to the upper rib 32a.

An arrow Fa indicated with the broken line in FIG. 15 indicates a flow path of a gaseous body flowing from the ink ejection head 17, which is arranged in the inner space 2a, in the +Y direction, that is, toward the opening/closing lever 21, and the gaseous body contains the ink mist.

However, as illustrated in FIG. 15, the flow path Fa is narrowed and meanders due to the lower rib 31e and the upper rib 32a. With this, the flow of the gaseous body flowing from the ink ejection head 17 toward the opening/closing lever 21 is inhibited, and the ink mist is easily captured by the lower rib 31e and the upper rib 32a. As a result, adhesion of the ink mist to the opening/closing lever 21 can be suppressed, and a hand and a finger of a user can be prevented from getting dirty.

In this manner, the lower rib 31e (31) and the upper rib 32a (32) constitute a meandering formation portion 30A that narrows the flow path of the gaseous body flowing from the ink ejection head 17 toward the opening/closing lever 21 and causes the flow path thereof to meander.

Note that there are a plurality of embodiments for the meandering formation portion. When it is not necessary to distinguish the respective meandering formation portions, they are collectively referred to as meandering formation portions 30.

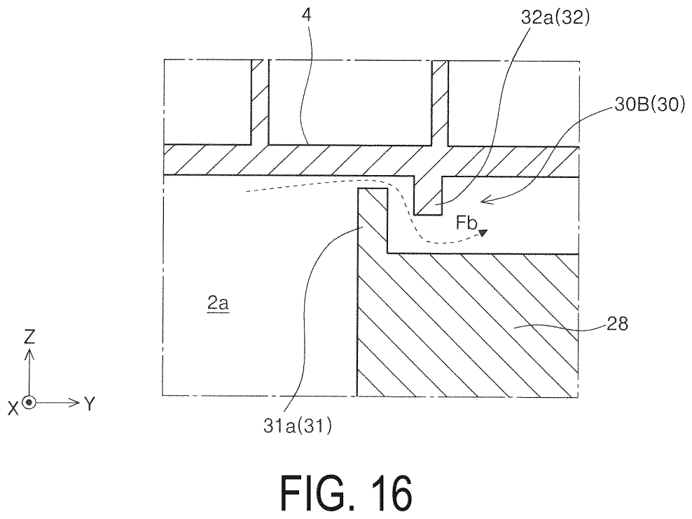

Further, FIG. 14 is a cross-sectional view of the printer 1, which is taken along the Y-Z plane at the position corresponding to the operation panel 15, and FIG. 16 is an enlarged view of the part B in FIG. 14.

As illustrated in FIG. 14 and FIG. 16, when the scanner unit 3 is closed with respect to the device main body 2, the lower rib 31a and the upper rib 32a are arranged alternatingly along the Y-axis direction. Note that, in the present embodiment, the lower rib 31a is arranged in the −Y direction with respect to the upper rib 32a.

An arrow Fb indicated with the broken line in FIG. 16 indicates a flow path of a gaseous body flowing from the ink ejection head 17, which is positioned in the inner space 2a, in the +Y direction, that is, toward the operation panel 15, and the gaseous body contains the ink mist.

However, as illustrated in FIG. 16, the flow path Fb is narrowed and meanders due to the lower rib 31a and the upper rib 32a. With this, the flow of the gaseous body flowing from the ink ejection head 17 toward the operation panel 15 is inhibited, and the ink mist is easily captured by the lower rib 31a and the upper rib 32a. As a result, adhesion of the ink mist to the operation panel 15 can be suppressed, and a hand and a finger of a user can be prevented from getting dirty.

In this manner, the lower rib 31a (31) and the upper rib 32a (32) constitute a meandering formation portion 30B that narrows the flow path of the gaseous body flowing from the ink ejection head 17 toward the operation panel 15 and causes the flow path thereof to meander.

Note that, when the scanner unit 3 is closed with respect to the device main body 2, the upper rib 32a is positioned in the +Y direction with respect to the lower rib 31b of the front frame 28. In other words, the lower rib 31b and the upper rib 32a constitute the meandering formation portion 30 that narrows the flow path of the gaseous body flowing from the ink ejection head 17 toward the operation panel 15 and causes the flow path thereof to meander.

Further, when the scanner unit 3 is closed with respect to the device main body 2, the upper rib 32a is positioned in the +Y direction with respect to the lower rib 31d of the locking member 35. In other words, the lower rib 31d and the upper rib 32a constitute the meandering formation portion 30 that narrows the flow path of the gaseous body flowing from the ink ejection head 17 toward the operation panel 15 and causes the flow path thereof to meander.

Further, when the scanner unit 3 is closed with respect to the device main body 2, the upper rib 32b is positioned in the −X direction with respect to the lower rib 31c of the front frame 28. In other words, the lower rib 31c and the upper rib 32b constitute the meandering formation portion 30 that narrows the flow path of the gaseous body flowing from the ink ejection head 17 toward the operation panel 15 and causes the flow path thereof to meander.

Note that the meandering formation portion 30 may be provided to a part where adhesion of the ink mist to the operation unit can be suppressed, and may also be provided to a part where leakage of the ink mist to the outside of the device can be suppressed. As a result, leakage of the ink mist to the outside of the device can be suppressed.

Note that, in the present embodiment, the operation unit includes the opening/closing lever 21 and the operation panel 15. As a matter of course, the operation unit may include other components.

Further, the meandering formation portion 30 includes the lower rib 31 as the first projection portion that projects from the device main body 2 toward the scanner unit 3 and the upper rib 32 as the second projection portion that projects from the scanner unit 3 toward the device main body 2. With this, the meandering formation portion 30 can be configured with a simple structure and low cost.

Further, in the present embodiment, the lower rib 31 and the upper rib 32 overlap with each other in the vertical direction. With this, the flow path of the ink mist from the ink ejection head 17 to the outside of the device can securely be caused to meander.

Further, in the present embodiment, the lower rib 31 is arranged closer to the ink ejection head 17 with respect to the upper rib 32. Thus, the following actions and effects can be obtained.

When the gaseous body containing the ink mist rides an updraft, the ink mist moves to the outside of the device through the gap between the scanner unit 3 and the device main body 2. Therefore, the ink mist is easily captured by the upper rib 32 that projects from the scanner unit 3 to the device main body 2, in other words, downward.

According to the configuration in which the lower rib 31 is arranged at the position close to the ink ejection head 17 with respect to the upper rib 32, the gaseous body containing the ink mist is guided to the upper rib 32 by the lower rib 31. With this, the ink mist can easily be captured by the upper rib 32, the ink mist flowing to the outside of the device can be reduced more securely.

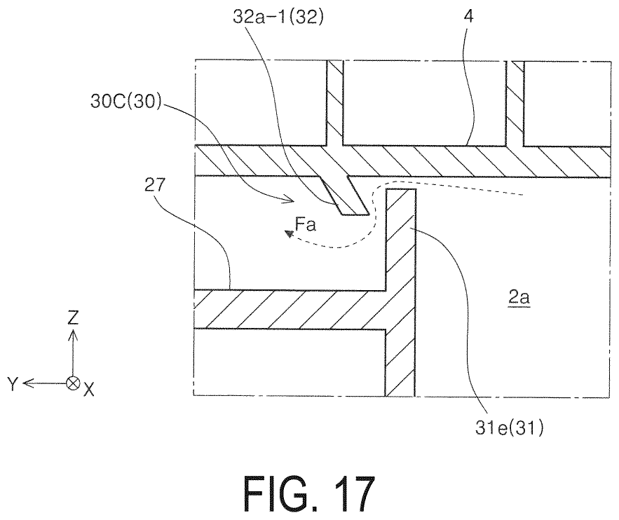

Note that the upper rib 32 may obliquely project toward the ink ejection head 17. FIG. 17 illustrates a meandering formation portion 35C being a modification of the embodiment illustrated in FIG. 15.

An upper rib 32a-1 obliquely projects toward the ink ejection head 17. With this, the ink mist can be captured more easily by the upper rib 32a-1, and the ink mist flowing to the outside of the device can be reduced more securely.

Note that, in the present embodiment, the meandering formation portion 30 is formed by the first projection portion that projects from the device main body 2 toward the scanner unit 3 and the second projection portion that projects from the scanner unit 3 toward the device main body 2. However, the meandering formation portion 30 may be configured by only one of the first projection portion or the second projection portion.

Further, one of the device main body 2 or the scanner unit 3 may be provided with a projection portion that projects toward the other thereof, and the other of the device main body 2 and the scanner unit 3 may be provided with a recess portion into which the projection portion is inserted. Further, the projection portion and the recess portion may constitute the meandering formation portion 30.

In other words, the meandering formation portion 30 is only required to be configured so as to narrow the flow path of the gaseous body flowing from the ink ejection head 17 to the outside of the device and cause the flow path thereof to meander.

Further, the present disclosure is not limited to the above-described embodiment and modification examples, various modifications can be made within the scope of the disclosure as described in the appended claims, and it is needless to say that the modifications also fall within the scope of the disclosure.

What is claimed is:

1. A liquid ejection device comprising:
a device main body including a liquid ejection head configured to eject a liquid onto a medium;
a reading unit configured to open and close at an upper part of the device main body and read an image on a document; and
an operation unit on which a user performs an operation, wherein
a flow path of a gaseous body is formed between the device main body and the reading unit, the gaseous body flowing in a direction from the liquid ejection head to the operation unit, and
a meandering formation portion is provided to a part of the flow path, the meandering formation portion narrowing the flow path and causing the flow path to meander.

2. A liquid ejection device according to claim 1, comprising:
a liquid accommodation unit configured to accommodates a liquid ejected from the liquid ejection head, wherein
the liquid accommodation unit is arranged at a device front surface being a side surface facing a user among side surfaces of a main body,
the liquid accommodation unit includes:
an injection port for a liquid; and
an opening/closing lever configured to open and close the injection port, and
the operation unit is the opening/closing lever.

3. A liquid ejection device according to claim 1, comprising
an operation panel configured to receive various operations, wherein
the operation panel is arranged on a device front surface being a side surface facing a user among side surfaces of the device main body, and
the operation unit is the operation panel.

4. A liquid ejection device according to claim 1, comprising
a liquid accommodation unit configured to accommodate a liquid ejected from the liquid ejection head, the liquid accommodation unit being arranged on a device front surface being a side surface facing a user among side surfaces of the device main body;
an operation panel configured to receive various operations, the operation panel being arranged on the device front surface; and
a plurality of the operations units, wherein
the liquid accommodation unit includes:
an injection port for a liquid; and
an opening/closing lever configured to open and close the injection port, and
the plurality of operation units include the opening/closing lever and the operation panel.

5. A liquid ejection device comprising:
a device main body including a liquid ejection head configured to eject a liquid onto a medium; and
a reading unit configured to open and close at an upper part of the device main body and read an image on a document, wherein
a flow path of a gaseous body is formed between the device main body and the reading unit, the gaseous body flowing in a direction from the liquid ejection head to an outside of the device, and
a meandering formation portion is provided to a part of the flow path, the meandering formation portion narrowing the flow path and causing the flow path to meander.

6. A liquid ejection device according to claim 1, wherein
the meandering formation portion includes:
a first projection portion that projects from the device main body toward the reading unit; and
a second projection portion that projects from the reading unit toward the device main body, and
the first projection portion and the second projection portion overlap with each other in a vertical direction.

7. A liquid ejection device according to claim 6, wherein
the first projection portion is arranged at a position closer to the liquid ejection head than the second projection portion.

8. A liquid ejection device according to claim 7, wherein
the second projection portion projects obliquely toward the liquid ejection head.
